(19) United States
(12) Patent Application Publication
(10) Pub. No.: US 2009/0139494 A1
(43) Pub. Date: Jun. 4, 2009

(54) DUAL PISTON DIRECT INJECTION FUEL PUMP

(75) Inventor: Patrick Powell, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 11/949,807

(22) Filed: Dec. 4, 2007

(51) Int. Cl. F02M 37/06; F04B 35/01

(52) U.S. Cl. 123/508; 417/364

(57) ABSTRACT

A fuel pump for an automotive application includes two separate pumping chambers within each of which a piston is reciprocated in order to pump fuel to an engine for the automobile. The dual cylinder arrangement increases the output capacity of the fuel pump.

### FIELD

The present disclosure relates to fuel pumps. More particularly, the present disclosure relates to dual piston direct injection fuel pumps.

### BACKGROUND

The statements in this section merely provide background information related to the present disclosure and may not constitute prior art.

Conventional gasoline engines are designed to use an electronic fuel injection system, replacing the traditional mechanical carburation systems. Port-Fuel Injection (PFI), where the fuel is injected through each intake port, is currently one of the popular systems used today. Although PFI provides a drastic improvement in response and quality, it is still limited due to the fuel and air mixing prior to entering the engine's cylinder.

In order to further increase response time and combustion efficiency, while lowering the fuel consumption and increasing output, designers are turning towards direct injection systems. Gasoline direct injection engines are engineered to inject the gasoline directly into the engine's cylinder in a manner similar to diesel direct injection engines.

Direct injection systems are designed to allow greater control and precision, resulting in better fuel economy. This is accomplished by enabling combustion of an ultra-lean mixture under many operating conditions. Direct injection is also designed to allow higher compression ratios and to deliver higher performance with lower fuel consumption.

In a direct injection system, the gasoline is highly pressurized because it is injected via a common rail fuel line directly into the combustion chamber of each cylinder. In PFI systems, or low pressure applications, turbine impeller fuel pumps can be used to deliver fuel from the fuel tank to the fuel rails and cylinders of the engine. However, conventional turbine impeller fuel pumps cannot deliver fuel at the pressures required by the direct injection systems. Piston type fuel pumps are more capable of delivering the fuel at these higher fuel pressures.

Current designs for piston type fuel pumps incorporate a single piston/cylinder design. The newer designs for vehicle engines include engines that have higher outputs and/or engines for flex fuel vehicles. These newer designs for engines require a higher flow rate of fuel and the current single piston/cylinder designs for fuel pumps are not able to meet this increased flow rate requirement.

One typical solution is to add a second fuel pump to an engine which would then double the amount of fuel delivery. Although this does solve the problem, adding a second fuel pump is expensive and packaging space to mount the second pump is limited.

### SUMMARY

The present disclosure provides a fuel pump which meets the increase in flow rate requirements without adding a second pump. The pump design of the present disclosure is a dual piston design which makes use of one pump which has twice the delivery rate. Even though the dual piston pump is larger in size due to the second cylinder, the overall packaging required to mount the pump is less than the overall packaging for a second pump.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of an automobile incorporating a direct fuel injection system in accordance with the present disclosure;

FIG. 2 is a schematic view of a direct fuel injection system in accordance with the present disclosure;

FIG. 3 is a side view of the fuel tank module illustrated in FIGS. 1 and 2;

FIG. 4 is a top view of the fuel pump in accordance with the present disclosure;

FIG. 5 is a side view partially in cross-section of the fuel pump illustrated in FIG. 4; and

FIG. 6 is a schematic diagram of the fuel pump illustrated in FIG. 4.

### DETAILED DESCRIPTION

The following description is merely exemplary in nature and is not intended to limit the present disclosure, application, or uses.

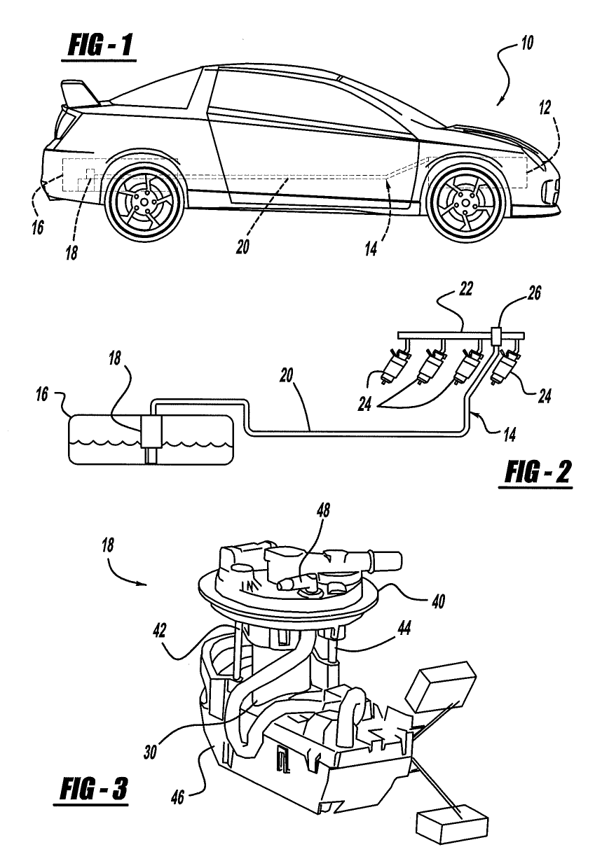

FIGS. 1-3 illustrate a vehicle 10, such as an automobile, having an engine 12 and a direct fuel injection system 14. Direct fuel injection system 14 comprises a fuel tank 16, a fuel tank module 18, a fuel supply line 20, a fuel injector rail 22, a plurality of fuel injectors 24 and a direct injection pump 26.

Fuel tank 16 is typically located in the rear of vehicle 10 with fuel tank module 18 being located within fuel tank 16. Fuel supply line 20 extends from fuel tank module 18 to direct injection pump 26 which is typically located on or near engine 12 located in the front of vehicle 10. Direct injection pump increases the fuel pressure between fuel supply line 20 and fuel injector rail 22. Each fuel injector 24 is in communication with fuel injector rail 22 to receive fuel which is then injected directly into one of the cylinders of engine 12.

Direct fuel injection system 14 does not have a fuel return line from fuel injector rail 22 to fuel tank 16. Because of this, a fuel pump 30 within fuel tank module has its voltage varied to adjust the amount of fuel supplied to direct injection pump 22 which then supplies pressurized fuel to fuel injector rail 22 to maintain a specified fuel pressure within direct fuel injection system 14 as is dictated by the fuel demand from engine 12.

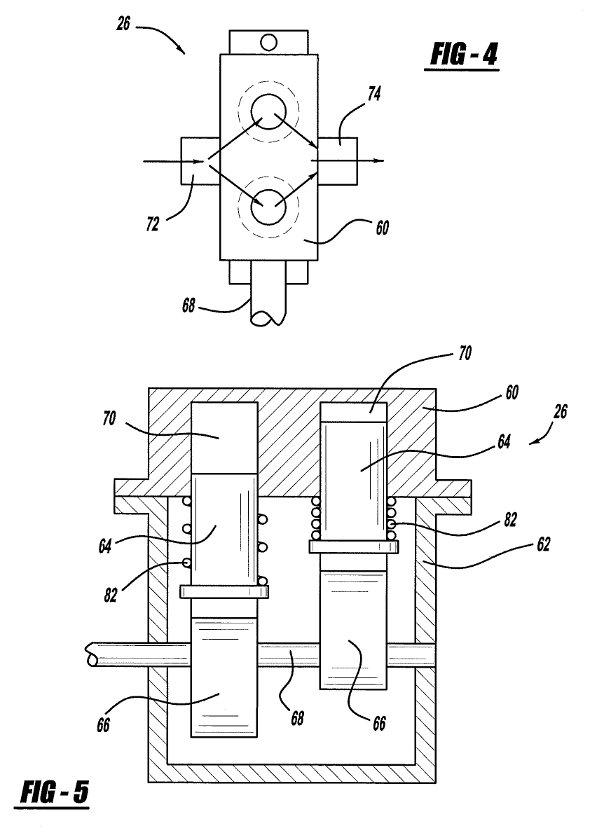

Referring to FIG. 3, fuel tank module 18 includes a flange 40 that mounts fuel tank module 18 to a specified mounting location on fuel tank 16. Flange 40 forms a seal, such as with an O-ring, with fuel tank 16 when fuel tank module 18 is secured to fuel tank 16. First and second reservoir rods 42, 44 position a fuel reservoir 46 at the bottom interior wall of fuel tank 16. From the top flange 40, an engine fuel line connector 48 protrudes to deliver fuel to fuel supply line 20 and eventually to engine 12 through fuel injector rail 22 and fuel injectors 24.

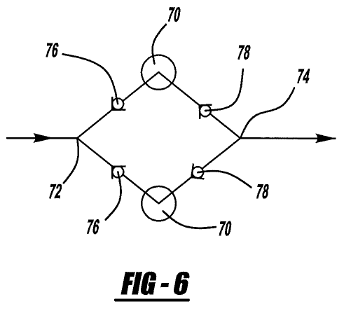

Referring now to FIGS. 4-6, direct injection fuel pump 26 is illustrated in greater detail. Direct injection fuel pump 26 comprises a cylinder head 60, a lower housing 62, a pair of pistons 64, a pair of cams 66 and an engine camshaft 68.

Cylinder head 60 defines two pumping cylinders 70. Each piston is disposed within a respective cylinder 70 and reciprocates within its respective cylinder 70 to pump fuel. Cylinder head 60 defines an inlet 72 leading to cylinders 70 and an outlet 74 leading from cylinders 70. An inlet check valve 76 is disposed between inlet 72 and each cylinder 70 and an outlet check valve 78 is disposed between outlet 74 and each cylinder 70 as illustrated in FIG. 6. Thus, during the reciprocal movement of pistons 64, fuel is supplied to each cylinder 70 through inlet 72 and check valves 76 and fuel is pumped by each piston 64 from cylinders 70 through check valves 78 and through outlet 74. Inlet 72 receives fuel from fuel supply line 20 and outlet 74 delivers fuel to fuel injector rail 22.

Lower housing 62 is sealingly attached to cylinder head 60. The pair of cams 66 are rotatably disposed on the engine camshaft 68. Each cam 66 engages an end of a respective piston 64 and each cam 66 has an exterior contour which provides the reciprocal movement of pistons 64 in cylinders 70 when cams 66 are rotated. A return spring or biasing member 82 attached to each piston 64 urges piston 64 into contact with its respective cam 66. Engine camshaft 68 causes rotation of cams 66 and the pumping of fuel by pistons 64 in cylinders 70.

What is claimed is:

1. A fuel pump for an automobile, the fuel pump comprising:
a cylinder head defining a first and a second pumping cylinder;
a first piston slidingly disposed within the first pumping cylinder;
a second piston slidingly disposed within the second pumping cylinder;
a housing attached to the cylinder head;
an inlet supplying fuel to the first and second pumping cylinders;
an outlet receiving fuel from the first and second pumping cylinders;
a cam system disposed within the housing, the cam system engaging the first and second pistons for causing the pistons to pump fuel from the inlet to the outlet through the pumping cylinders.

2. The fuel pump according to claim 1, wherein the cam system comprises a first cam engaging the first piston and a second cam engaging the second piston.

3. The fuel pump according to claim 1, further comprising a first biasing member urging the first piston into engagement with the cam system and a second biasing member urging the second piston into engagement with the cam system.

4. The fuel pump according to claim 1, wherein a linear center line connecting a center of each pumping cylinder crosses a linear flow line extending between the inlet and the outlet.

5. The fuel pump according to claim 5, wherein the center line is generally perpendicular to the flow line.

6. The fuel pump according to claim 1, further comprising a first check valve disposed between the inlet and the first pumping cylinder and a second check valve disposed between the inlet and the second pumping cylinder.

7. The fuel pump according to claim 6, further comprising a third check valve disposed between the outlet and the first pumping cylinder and a fourth check valve disposed between the outlet and the second pumping cylinder.

8. A fuel pump for an automobile, the fuel pump comprising:
a cylinder head defining a first and a second pumping cylinder;
a first piston slidingly disposed within the first pumping cylinder;
a second piston slidingly disposed within the second pumping cylinder;
a housing attached to the cylinder head;
an inlet supplying fuel to the first and second pumping cylinders;
a first check valve disposed between the inlet and the first pumping cylinder;
a second check valve disposed between the inlet and the second pumping cylinder;
an outlet receiving fuel from the first and second pumping cylinders;
a third check valve disposed between the first pumping cylinder and the outlet;
a fourth check valve disposed between the second pumping cylinder and the outlet;
a first cam disposed within the housing in engagement with the first piston;
a first biasing member urging the first piston into engagement with the first cam;
a second cam disposed within the housing in engagement with the second piston,
a second biasing member urging the second piston into engagement with the second cam; and
a linear center line connecting a center of each pumping cylinder crosses a linear flow line extending between the inlet and the outlet.

9. The fuel pump according to claim 8, wherein the center line is generally perpendicular to the flow line.
